(19) United States
(12) Patent Application Publication
(10) Pub. No.: US 2010/0275852 A1
(43) Pub. Date: Nov. 4, 2010

(54) PET FOOD DISH

(76) Inventors: John M. Lipscomb, Cedarburg, WI (US); Stanley L. Suring, Cedarburg, WI (US); Oing He, North Andover, MA (US)

Correspondence Address: BOYLE FREDRICKSON S.C., 840 North Plankinton Avenue, MILWAUKEE, WI, 53203, US

(21) Appl. No.: 12/432,389

(22) Filed: Apr. 29, 2009

(51) Int. Cl. A01K 1/10

(52) U.S. Cl. 119/61.5

(57) ABSTRACT

An animal feeding dish having a relatively shallow-food holding bowl that is upraised from the floor by a platform or pedestal so as to minimize whisker contact of an animal eating from the dish. The platform or pedestal can include spaced apart outwardly extending supports that shield interiorly disposed legs carried thereby from food dropped during eating while also preventing tipping of the dish. Such a bowl can be a spherical section having an advantageously large radius of curvature, including relative to bowl width or diameter, which produces a desirably shallow depth bowl that prevents whisker contact. The bottom most portion of the bowl is spaced suitably high relative to overall dish height to more optimally position the mouth of the animal during feeding to further minimize whisker contact.

### FIELD OF INVENTION

The present invention relates to a pet food dish, and more specifically to a pet food dish that has a shallow-depth food-holding bowl carried by a raised food platform advantageously designed for animal comfort and cleanliness.

### BACKGROUND

Dishes for feeding pets come in a wide variety of shapes and sizes. Standard dishes, shaped much like those for human use, are certainly known. However, pets, including cats and dogs, may step on or swat at the lip of this type of dish, flipping the dish over and spilling the contents. A well-known type of pet feeding dish that is not subject to flipping has an inner bowl portion and a frustoconical outer wall. Even more common are flat-bottomed bowls with upright, cylindrical walls, which are also difficult to flip.

Although both of these latter types of pet food dishes solve the problem of the animal flipping it over, both require the animal to stand with its feet outside the outer wall and outside the perimeter of the food-containing portion of the bowl. This is not a problem for large animals, but for small dogs, cats, and the like, standing back from the food-containing bowl of the dish requires straining forward to feed.

Furthermore, all of the dishes discussed thus far are relatively deep, presenting food at the bottom of the bowl, almost to the floor, with a wall over which the animal is required to reach its head to feed. In nature, however, animals more usually feed from a source at approximately their own height. The dishes of the prior art therefore typically present an unnatural feeding position.

Dishes with relatively deep bowls are particularly ill-suited for animals, such as cats, equipped with elongate tactile hairs, known as vibrassae or whiskers, which are extremely sensitive. In cats, there are four horizontal rows of whiskers that extend outwardly to each side from a whisker pad in the vicinity of the mouth and nose with some of those whiskers also extending somewhat forwardly therefrom. The longest whiskers of an adult cat are roughly as wide as its body, typically extending outwardly at least three inches outwardly from each side of the whisker pad.

If a cat must insert its head even partway into a bowl of a dish having a sidewall width or diameter of less than six inches and a depth such that its mouth and an adjacent part of its whisker pad is located more than about one-half of an inch below the top edge of the bowl when eating, the cat can brush its whiskers against the sides of the bowl. In addition, as a result of having to crane its neck to lower its head so it mouth can reach the food, the mouse pad ends up being disposed at an angle such that the whiskers of at least three of the horizontal whisker rows rub against the top edge and/or sidewall of the bowl. As a result of repetitive motion of whiskers that occurs during eating, this repeated brushing or rubbing can inflame the nerves in the whisker pad at the ends of the whiskers causing irritation. If this occurs, the cat may fail to eat enough and can fail to thrive. Cats with particularly sensitive whiskers that have become irritated have been known to stop eating altogether due to this problem.

Finally, overeating is a very serious problem that pets face as quite often the owner will fill up the bowl of the dish with many times the food the pet actually needs for daily consumption. While this is commonly done by cat owners, they do not realize that many cats will overeat. As a result, obesity in pets, including cats, can rob them of energy, vitality and can have serious health consequences.

What is needed is a pet feed dish that minimizes and preferably prevents whisker contact. What is also needed is a pet feed dish that minimizes overeating.

### SUMMARY OF THE INVENTION

An animal feeding dish of the present invention is difficult to tip and yet also provides a raised food bowl-carrying platform for a more natural eating position. The dish has a bowl and is configured to provide space for the animal to stand at the feeder without its feet being impeded by any outer wall of the bowl. The raised platform design of the bowl also accommodates a cat's whiskers so that feline pets are able to use the bowl. And, the bowl of the present invention is advantageously designed to prevent the feet of the device from becoming dirty and to make regular cleaning easier.

In a preferred embodiment, the bowl is a generally concave spherical section that can be bounded by an annular lip or sidewall with the bowl supported on a platform or pedestal integrally formed by at least a plurality of pairs, i.e., at least three, of downwardly and outwardly extending supports that each carry an interiorly disposed leg that is shielded thereby. Each leg can carry or receive a non-stick foot. Each support extends radially outwardly and downwardly helping provide a stable dish that cannot be easily tipped over. Each support can be a spherical curve that is curved along a downward and a transverse direction with its outer surface forming a curved shield that deflects dropped food away from the legs and feet.

The bowl is of a shallow depth that presents food high enough within the bowl for the animal to eat without irritating its whiskers. In one preferred embodiment, the bowl has a suitable width or diameter to depth ratio that produces a desirably shallow depth bowl that minimizes whisker contact while also holding a limited food portion that helps reduce animal overeating. Where the bowl is a generally spherical section, the bowl has a suitably desirable radius of curvature to bowl width or diameter ratio. The bowl can also be configured with a radius of curvature that produces respectively desirable surface area and volume ratios relative to a sphere having the same radius.

The supports raise the bowl along with food in the bowl a sufficient height so as to minimize craning of the animal's neck thereby positioning their mouth at a better angle relative to the food and dish that minimizes whisker contact. The bowl of the dish can have a bottom-most portion located at a desired relative height relative to overall bowl height off the floor. In a preferred embodiment, the dish has a suitably desirable relationship between overall height and the radius of curvature of the bowl.

### BRIEF DESCRIPTION OF THE DRAWINGS

FIG. 1 is a perspective view of a cat eating from a preferred embodiment of a dish of the present invention;

FIG. 2 is a perspective view of a cat seated at a preferred embodiment of the dish of the present invention;

FIG. 3 is a perspective view of a preferred embodiment of the dish of the present invention;

FIG. 4 is a top view of the dish shown in FIG. 3;

FIG. 5 is another side view of the dish shown in FIG. 3, taken from a first circumferential location;

FIG. 6 is a view of the bottom of the dish shown in FIG. 3;

FIG. 7 is a side view of the dish shown in FIG. 3, taken from a second circumferential location;

FIG. 8 is a side view of the dish shown in FIG. 4, taken from a third circumferential location;

FIG. 9 is a cutaway view of the view shown in FIG. 7 taken from lines 9-9 in FIG. 4; and

FIG. 10 is a cutaway view of the view shown in FIG. 8 taken from lines 10-10 in FIG. 4.

### DETAILED DESCRIPTION

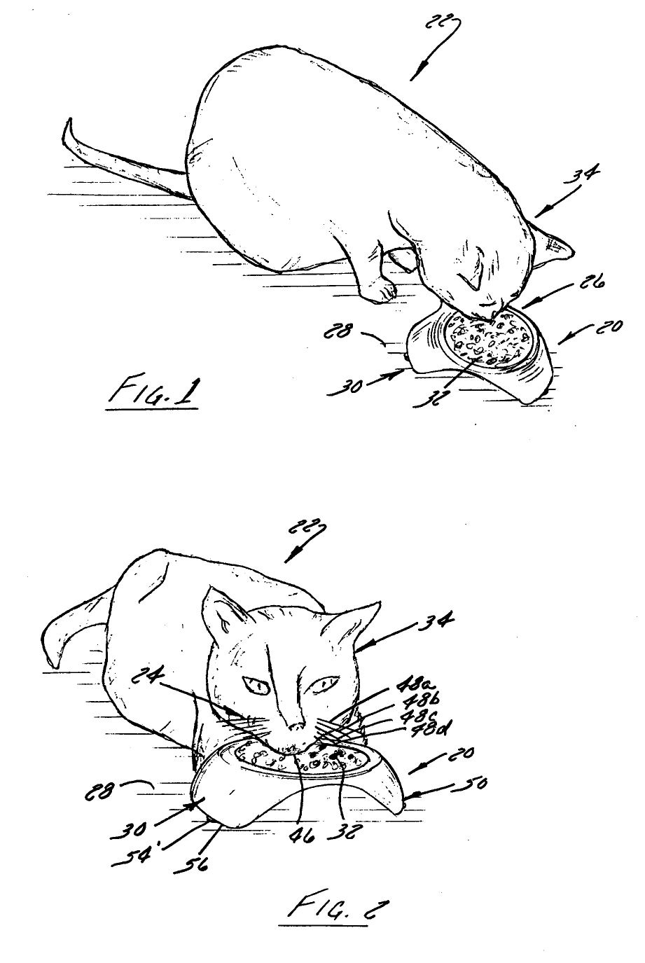

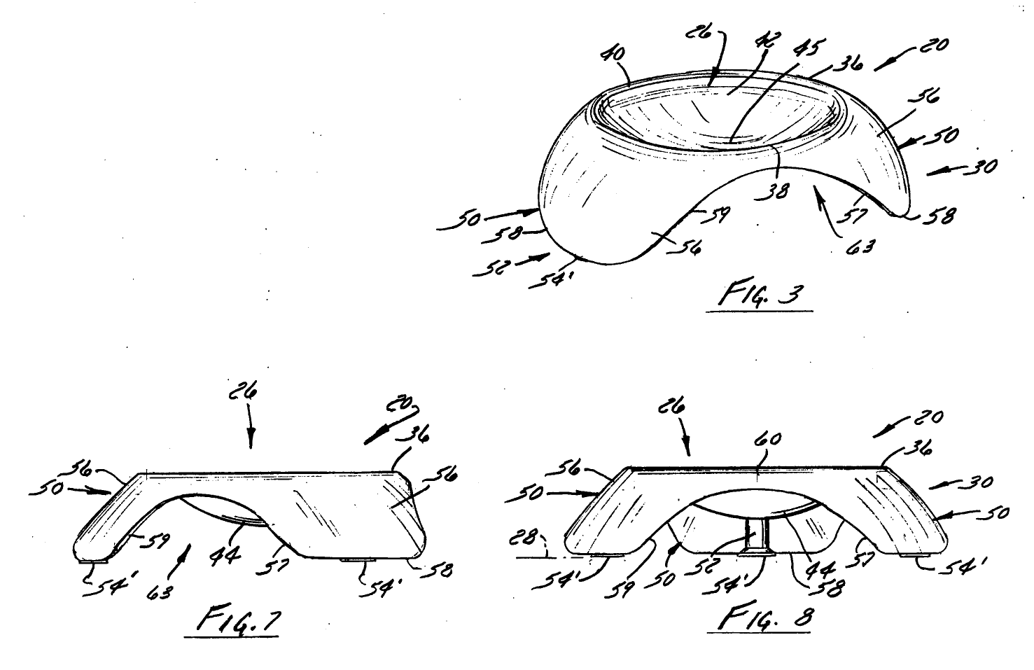

Referring to FIGS. 1 and 2, a preferred embodiment of a pet feeding dish 20 constructed in accordance with the present invention is shown with an animal 22 that is equipped with vibrissae or whiskers 24 eating from it. The pet feeding dish 20 is advantageously constructed and arranged with a bowl 26 of shallow depth that is upraised off the floor 28 on a pedestal 30 that enables the animal 22 to eat food 32 in the bowl 26 while minimizing whisker contact. As a result of the height the bowl 26 is raised up off the floor 28, the head 34 of the animal 22 is better positioned to reduce the likelihood of whiskers 24 contacting the dish 20 as well as the food 32. As a result of the bowl 26 being of shallow construction, whisker contact is further minimized because the food 32 is up high relative to any outer top periphery of the bowl 26. Although the animal 22 shown in FIGS. 1 and 2 is a cat, dish 20 is intended for use with any type of animal that has whiskers.

Dish 20 stands on the floor 28 or other surface, and, as better seen in FIG. 3, includes bowl 26 for containing pet food 32. With continued reference to FIG. 3, bowl 26 has an uppermost margin 36 and a circumference 38. Preferably, a relatively thin annular sidewall or lip 40 runs about circumference 38 from uppermost margin 36 to a concave bowl surface 42 to prevent food 32 in bowl 26 from being pushed out of bowl 26. Bowl 26 also has a lowest point 44, or bottom, that is raised from the floor 28 spacing the bottom-most portion 45 of the bowl surface 42 above the floor 28 reducing the distance the animal 22 has to lower its head 34 when eating.

More particularly, bowl 26 is raised up above floor 28 to permit a pet 22 to eat food 32 from the bowl substantially without craning its neck. As a result, the food 32 is presented higher relative to the position of the mouth 46 (FIG. 2) of the pet 22 thereby positioning at least a plurality of the rows 48a, 48b, 48c and 48d of whiskers 24 above and out of reach from contacting any part of the dish 20. As a result, whisker irritation and inflammation is advantageously minimized.

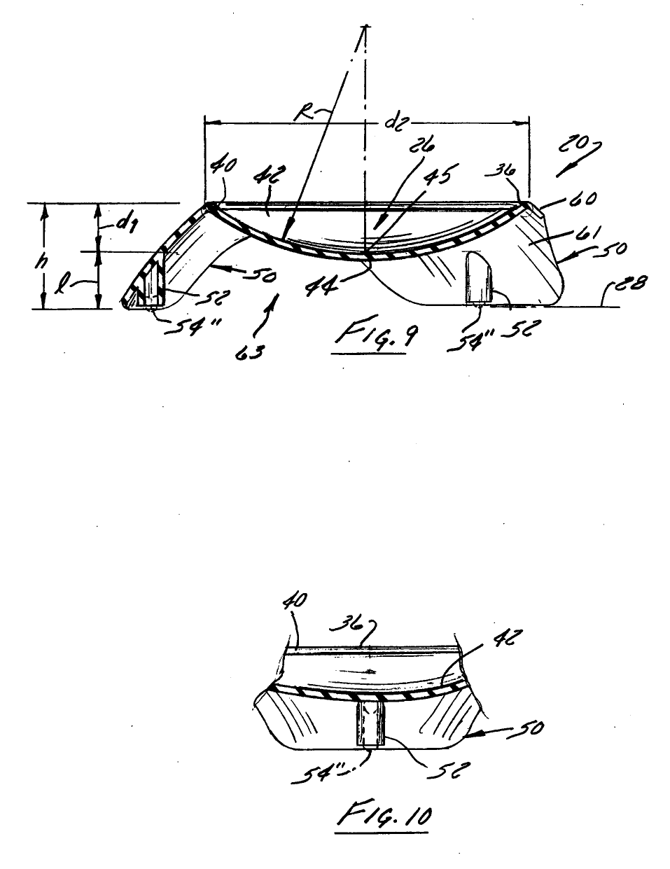

In a preferred embodiment, bottom-most point 45 of the bowl 26 is located no lower than one-half the distance of the total height at the margin 36 of the bowl 26. In a preferred embodiment, bottom-most point 45 of the bowl surface 42 is located no lower than about sixty percent of the total height to the margin 36 of the dish 20 (e.g. sixty percent plus or minus five percent). For example, with reference to FIG. 9, a currently preferred embodiment of a dish 20 equipped with a bowl 26 configured to hold no more than four ounces of pet food 32 (about three ounces) has a height, h, extending from margin 36 where its height is greatest down to the floor 28 of about one and one-quarter inches (about 32 mm) and a depth, d₁, at the lowest point of the bowl 26 up to margin 36 of about seven sixteenths of an inch (about 11.5 mm). As such, the lowest point 45 of the bowl 26 is located a distance, l, that is about thirteen-sixteenths of an inch (about 20.5 mm) above the floor 28 or about 64% of the total height, h, of the dish 20. This advantageously helps position the bottom of the bowl 26 suitably high to minimize craning of the neck of a pet 22 eating food 32 in the bowl 26. This also helps more ergonomically position the mouth of the pet 22 during eating so as to minimize whisker contact with the dish 20. Another preferred dish embodiment constructed in accordance with the present invention meets these criteria and has a bowl 26 configured to hold no more than six ounces (about five ounces) of food 32.

In addition, bowl 26 has a shallow bowl depth which further helps a pet 22 eating food 32 in the bowl 26 to do so while helping to prevent its whiskers from coming into contact with any part of the dish 20. In a preferred embodiment, the bowl 26 of the dish 20 has a ratio of bowl width or diameter, d₂ (FIG. 9) to bowl depth, d₁, of at least six and a half thereby producing a suitably desirably shallow bowl depth. In another preferred embodiment, the ratio of bowl width or diameter to bowl depth, namely d₂/d₁, is at least seven. For example, with reference to FIG. 9, a currently preferred embodiment of a dish 20 equipped with a bowl 26 has a width or diameter, d₂, of about three and a half inches (about 90 mm) and a depth, d₁, as discussed above, of about seven sixteenths of an inch (about 11.5 mm) for a d₂/d₁ ratio of about 7.8. A bowl 26 having such a d₂/d₁ ratio relationship produces a suitably shallow bowl depth having a desirable bowl size for holding sufficient food for a pet 22 that preferably is a cat while minimizing and preferably preventing whisker contact with any part of the dish 20. As also discussed above, another preferred dish embodiment constructed in accordance with the present invention meets the above d₂/d₁ ratio criteria and has a bowl 26 configured to hold no more than six ounces (about five ounces) of food 32.

In the preferred embodiment shown in the drawing figures, the concave bowl surface 42 is a generally spherical section having a relatively large radius of curvature, r, compared to conventional pet food dishes thereby helping to impart the desirably advantageous shallow bowl depth that minimizes whisker contact with the dish 20. The radius of curvature, r, is best seen in FIG. 9, where the wide, shallow character of bowl 26 is shown. A bowl 26 of a pet food dish 20 constructed in accordance with the present invention has a ratio of the radius of curvature, r, relative to the width across the bowl 26 or bowl diameter, d₂, that is greater than one and has a ratio of bowl width or diameter, d₂, to bowl depth, d₁, of at least five thereby producing a suitably shallow depth bowl 26. In a preferred embodiment, the ratio of radius of curvature to bowl width or diameter, namely, r/d₂ is greater than 1.2 and the ratio of bowl width or diameter to bowl depth, namely d₂/d₁, is greater than six and a half where the bowl is configured to hold no more than four ounces of pet food (about three ounces). In another preferred embodiment, the ratio of radius of curvature to bowl width or diameter, namely, r/d₂ is greater than one and one-quarter and the ratio d₂/d₁ is at least seven. For example, with reference to FIG. 9, a currently preferred embodiment of a dish 20 equipped with a bowl 26 has a radius of curvature, r, of between four and one-half inches and five inches (about four and thirteen sixteenths inches or about 122 mm), a width or diameter, d₂, of about three and a half inches (about 90 mm) and a depth, d₁, as discussed above, of about seven sixteenths of an inch (about 11.5 mm). As also discussed above, another preferred dish embodiment constructed in accordance with the present invention meets the aforementioned criteria and has a bowl 26 configured to hold no more than six ounces (about five ounces) of food 32.

A dish 20 constructed in accordance with the present invention can also be configured with a radius of curvature, r, of the surface 42 of the bowl 26 that is at least three times the height, h, of the dish 20 thereby helping to ensure that the bowl 26 has a desirably shallow depth and is located at a suitably high height to minimize the pet 22 having to crane or bend down further helping to prevent whisker contact with dish 20. In another preferred embodiment, the radius of curvature, r, of the generally spherical bowl surface 42 is at least 3.2 times dish height, h. For example, with the dish 20 equipped with a bowl 26 configured to hold no more than four ounces of pet food 32 (about three ounces) having a height, h, of about one and one-quarter inches (about 32 mm) and a radius of curvature, r, of about four and thirteen sixteenths inches (about 122 mm) for a r/h ratio of about 3.5. Such a relationship between height and radius of curvature also helps ensure that a dish 20 constructed in accordance with the present invention has a bowl 26 with a desirably shallow depth that is of a height that minimizes stooping or craning of the pet during eating. As also previously discussed, another preferred dish embodiment constructed in accordance with the present invention meets the aforementioned criteria and has a bowl 26 configured to hold no more than six ounces (about five ounces) of food 32.

In a preferred embodiment, where the inner surface 42 of the bowl 26 is configured as a concave spherical section with radius of curvature, r, the bowl surface 42 has a surface area that is no greater than one-sixth the total surface area of a sphere having the same radius of curvature, r, thereby producing a bowl 26 that is also suitably shallow in depth to minimize whisker contact. In another preferred embodiment, the bowl 26 is configured as a concave spherical section with a radius of curvature, r, which provides a bowl surface area no greater than one-eighth the total surface area of a sphere having the same radius of curvature. In another preferred embodiment, the bowl 26 is also configured as a concave substantially spherical section with a radius of curvature, r, which produces a volume that is no greater than 1/100^{th} of the volume of a sphere having the same radius of curvature. In a further preferred embodiment, the bowl 26 is a substantially spherical section having a radius of curvature, r, which results in a volume no greater than 1/120^{th} of the volume of a sphere having the same radius of curvature.

The surface 42 of the bowl 26 can intersect an outer annular lip or wall 40 that extends upwardly to the uppermost margin 36. Where the dish 20 includes such a lip or wall 40, it preferably extends downwardly generally axially from the margin 36 to the bowl surface 42 no more than two-fifth the total depth, d, of the bowl 26. In one preferred embodiment, the lip or wall 40 extends downwardly no more than about one-third the total depth, d, of the bowl 26. For example, where the depth, d, of a bowl 26 of a dish 20 that is configured to hold no more than four ounces of pet food is about seven sixteenths of an inch (about 11.5 mm), the lip or wall 40 extends from the margin 36 downwardly to the bowl surface 42 about five thirty-seconds of an inch (about 4 mm).

Bowl 26 is raised from floor 28 by way of downwardly extending supports 50 that each includes an inwardly disposed leg 52 that extends downwardly from an inner surface 61 of its support 50. Each one of the supports 50, along with its respective leg 52, is preferably formed integrally with bowl 26 to form dish 20. Supports 50 extend outwardly and downwardly from circumference 38 of bowl 26 to provide a wide base and thus prevent tipping. Each support 50 is curved downwardly and outwardly to avoid contacting any whisker of a pet eating from the dish 20 as well as to cause food dropped by the pet to be deflected further outwardly. In a preferred embodiment, each support 50 extends at least three quarters of an inch (about 19 mm) from circumference 38 of bowl 26 to where it terminates at or adjacent the floor 28. In a preferred embodiment, each support 50 extends outwardly about an inch (about 25 mm). Preferably dish 20 has at least three supports 50 for maximum stability, but providing additional supports is well within the scope of the invention.

Legs 52 are, as noted above, preferably integrally formed with dish 20 and are structures capable of holding a foot 54′ or 54″ (shown in phantom in FIGS. 9 and 10) that preferably is made of a non-slip material, such as rubber, which prevents the dish 20 from moving on the floor 28. Foot 54′ shown in FIGS. 1-7 can be in the form of a suction cup and foot 54″ depicted in phantom in FIGS. 9 and 10 is in the form of a rubber plug or the like. If legs 52 are designed to hold a suction cup member, they may be tubular structures into which a projection of the foot 54′ or 54″ may be inserted. Alternately, any foot structure, preferably of a non-skid material that will not damage floors, can be used. Indeed, dish 20 may be used without feet if desired, as seen in FIGS. 9 and 10. In the embodiment shown in the accompanying figures, legs 52 are tubular structures approximately 0.6 inch in height (about 15 mm) and about five-sixteenths of an inch across (about 8 mm). If desired, each leg 52 with a suction cup foot 54′ attached can be substantially flush with the bottom edge of its corresponding support 50.

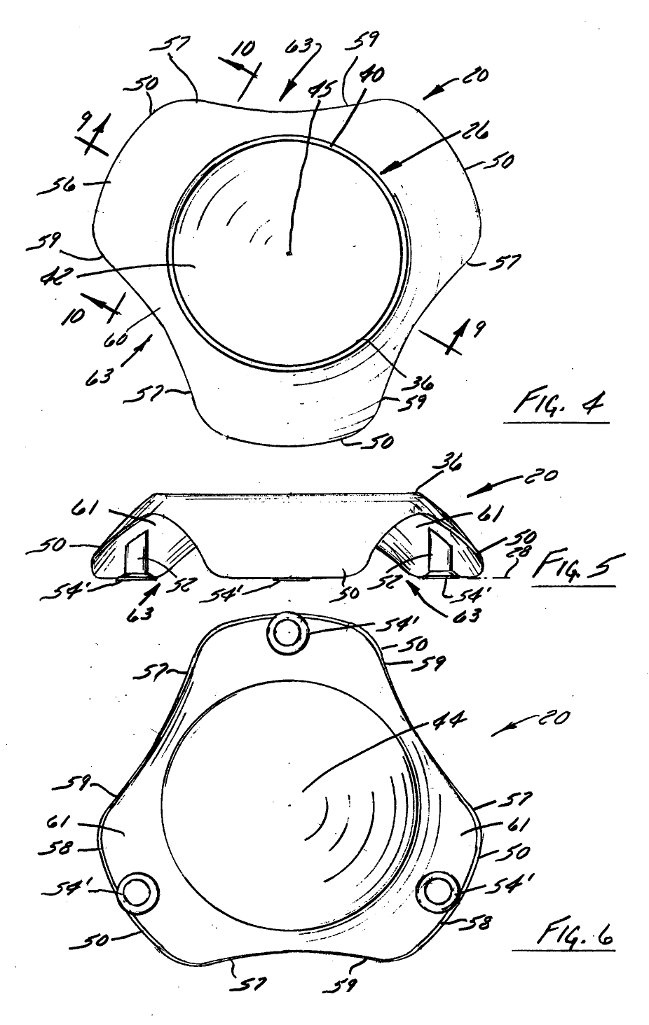

In another preferred embodiment, the legs 52 do not extend the entire height of dish 20, and do not extend quite to floor 28 such that when feet 54″ are assembled, they can be substantially flush with the bottom edge of its corresponding adjacent support 50. As best seen in FIGS. 9 and 10, in one preferred embodiment, legs 52 are substantially flush with the bottom edge of its corresponding support. As is best shown in FIG. 6, each support 50 carries and curves about a respective one of the legs 52 so as to protect the leg 52 and keep food from it.

Each support 50 has an outer surface that defines a shield 56 which prevents food and other foreign materials from coming into contact with feet 54′ or 54″, thus preventing their accumulation in those key areas. Shields 56 are preferably outwardly and downwardly sloped, as seen in FIG. 3, to direct falling foodstuff away from dish 20, thus maximizing the chance that the food will not become trapped under dish 20. Shields 56 also prevent foreign objects from entering the underside of the dish. As best seen in FIG. 5, shields 56 also preferably have a bottom edge 58 parallel to the plane of floor 28 so that shields 56 can be used to support dish 20 when legs 52 or feet 54′ or 54″ are not used.

Each support 50 is spaced apart from each adjacent support 50 in order to provide a space 63 therebetween. The space 63 allows a pet to stand almost directly next to bowl 26, advantageously providing closer food access, with its paws also being able to be extended somewhat under bowl 26, so that no craning of the neck is necessary in order to reach its food. The space is also large enough to permit a pet 22 that is a cat to reach a paw underneath to retrieve food 32 that may have somehow gotten underneath the bowl 26. In addition, the space between adjacent supports 50 allows ventilation underneath the bowl 26. However, each of supports 50 is also preferably connected to adjacent supports 50 adjacent to uppermost margin 36, forming a flange or skirt 60, best seen in FIGS. 3 and 4. As with shields 56, skirt 60 promotes cleanliness by providing an outwardly sloping surface that acts to prevent food from falling directly downward and accumulating under the bowl 26 of dish 20.

In the preferred dish embodiment shown in the drawing figures, there are three such supports 50 that are substantially equiangularly spaced about the center 45 of the bowl 26. Each support 50 preferably is defined as being a spherical curve that is curved downwardly from margin 36 toward floor 28, that is also curved in a transverse or circumferential direction from one side edge 57 to its other side edge 59, and that is also curved along its bottom edge 58. Such a smooth downwardly sloping and curved support defining a shield 56 that not only deflects food and other debris outwardly away from the legs and feet, it is also sloped in a manner that minimizes interference with a pet 22 approaching and eating from the bowl 26 of the dish. If desired, the three supports/shields can have the general form of a three-petalled mathematical rose.

Dish 20 is designed to be generally wide and low to the ground, producing a stable feeding dish that also raises food to an animal's height. Overall, in one preferred embodiment, dish 20 rises about one and one-eighth of an inch (about 28.5 mm) from support surface 22 and has an overall diameter of over four times its height, i.e. approximately six inches (about 152 mm). Bowl 26 is about three and a half inches in diameter (about 89 mm) and 0.6 of an inch deep (about 15 mm). Each support 50 extends outwardly from bowl 26 approximately one inch (about 25 mm).

The dish 20, including the bowl 26, supports 50, skirt 60, and legs 52 are preferably constructed of a unitary piece of material, such as plastic, and dish 20 preferably has a smooth exterior surface for ease of cleaning. In a preferred embodiment, the dish 20 is made of a translucent plastic that enables a pet owner to see through and underneath the bowl 26 and through other parts of the dish 20 to the floor 28 making it easier to determine when cleaning underneath the dish 20 should be performed. Due to the low and wide design, dish 20 is able to fit conveniently in a standard dishwasher, and is preferably constructed of a dishwasher-safe material. Advantageously, the low and wide design allows multiple dishes to be stacked atop one another for economical shipping and retail display.

Such a dish 20 is particularly well suited for use with domestic cats and is capable of holding kibble, semi-moist cat food and canned or pouched cat food that is wet, such as including gravy or the like and having as much as a 75%-78% moisture content. By providing bowl sizes of no more than four ounces in one preferred embodiment and no more than six ounces in another preferred embodiment, the tendency of cats to overeat is reduced if not prevented by limiting the portion size that the dish 20 can hold. In another preferred embodiment, such a dish 20 can also be configured for use with dogs with the dish 20 having a larger bowl 26 and located even higher off the floor 28 than the above-defined dish that is configured to hold no more than six ounces of food.

It should be understood that, although the foregoing description and drawings describe and illustrate in detail one preferred embodiment of the present invention, to those skilled in the art to which the present invention relates, the present disclosure will suggest many modifications and constructions as well as widely differing embodiments and applications without departing from the spirit and scope of the invention. The present invention, therefore, is intended to be limited only by the scope of the appended claims.

It is claimed:

1. A pet feeding dish comprising a bowl supported by a plurality of spaced apart feet that raise a bottom of the bowl above a support surface upon which the feet rest thereby raising the bowl off of the floor.

2. The pet feeding dish of claim 1 further comprising a shield overlying each foot preventing food in the bowl from coming into contact with the associated foot.

3. The pet feeding dish of claim 2 wherein there is a space between adjacent shields permitting access by a pet to the bowl to facilitate access to food in the bowl.

4. The pet feeding dish of claim 3 wherein the space between adjacent shields permits air flow therebetween and underneath the bottom of the bowl.

5. The pet feeding dish of claim 4 wherein a bottom edge of each shield is spaced slightly above the support surface permitting air flow between the bottom edge and the support surface.

6. The pet feeding dish of claim 2 wherein each shield extends outwardly and downwardly.

7. The pet feeding dish of claim 6 wherein each shield extends outwardly and downwardly substantially to the support surface.

8. The pet feeding dish of claim 1 wherein the bowl has a radius of curvature that produces a shallow bowl depth enabling the pet to eat food in the bowl without any whiskers of the pet coming into contact with the bowl.

9. The pet feeding dish of claim 1 wherein the bottom of the bowl is upraised high enough above the support surface to permit a pet to eat food in the bowl substantially without craning its neck.

10. A pet feeding dish comprising:
a pedestal comprised of a plurality of supports that overlie a support surface;
a concave bowl carried by the pedestal that has a shallow depth that holds and presents pet food in the bowl at a height relative to an upper margin of the bowl that prevents whiskers of a pet eating the food from contacting the dish.

11. The pet feeding dish of claim 10 wherein each support is disposed outwardly of the outer periphery of the bowl and comprises a shield that overlies a leg carried by the support with each shield spaced apart from each adjacent shield so as to define a space therebetween.

12. The pet feeding dish of claim 10 wherein pedestal comprises at least three supports spaced apart about the bowl and extending outwardly of the bowl and the support surface comprises a floor upon which the supports rest.

13. The pet feeding dish of claim 12 wherein each support comprises a spherical curve that is curved in a downwardly direction from adjacent the margin to adjacent the floor and that is curved in a transverse direction.

14. The pet feeding dish of claim 10 wherein the bowl has a width and a depth and has a width to depth ratio of at least six and a half producing a shallow depth bowl that facilitates eating by a pet without whisker contact with the dish.

15. The pet feeding dish of claim 10 wherein the bowl comprises a substantially spherical section defined by a radius of curvature, a depth and a width has a ratio of radius curvature to width of at least one and a ratio of width divided by depth of at least five producing a shallow depth bowl.

16. The pet feeding dish of claim 15 wherein the width of the bowl comprises a diameter of the bowl.

17. The pet feeding dish of claim 16 wherein the bowl includes a concave surface comprising a substantially spherical section that is bounded by a lip or annular sidewall.

18. The pet feeding dish of claim 10 wherein the bowl comprises a substantially spherical bowl surface section defined by a radius of curvature producing a bowl surface area that is no greater than one-sixth the total surface area of a sphere having the same radius of curvature.

19. The pet feeding dish of claim 10 wherein the bowl comprises a substantially spherical bowl surface section defined by a radius of curvature producing a bowl volume that is no greater than 1/100th the total volume of a sphere having the same radius of curvature.

20. A pet feeding dish comprising:
a bowl having a concave bowl surface that comprises a generally spherical section; and
a pedestal comprised of at least three circumferentially spaced apart supports extending downwardly and outwardly from adjacent an outer periphery of the bowl with each support having a space therebetween.

21. The pet feeding dish of claim 20 wherein each one of the supports comprises a spherical curve that is curved in a longitudinal direction downwardly toward the floor and a transverse direction defining an outer surface that is a food-deflecting shield.

22. The pet feeding dish of claim 21 wherein each one of the supports comprises a leg that extends downwardly from an inner surface of the support.
